(19) United States
(12) Patent Application Publication
(10) Pub. No.: US 2019/0074705 A1
(43) Pub. Date: Mar. 7, 2019

(54) Method For Adaptive Load Modulation

(71) Applicant: Humavox Ltd., Kfar-Saba (IL)

(72) Inventors: Oded Golan, Tel Aviv (IL); Asaf Manova-Elssibony, Tel-Aviv (IL)

(21) Appl. No.: 16/120,280

(22) Filed: Sep. 2, 2018

Related U.S. Application Data
(60) Provisional application No. 62/553,815, filed on Sep. 2, 2017.

(51) Int. Cl. H02J 7/00; H02J 7/02

(52) U.S. Cl. CPC H02J 7/0072; H02J 7/025

(57) ABSTRACT

The present invention provides for an apparatus and method to change the load of the load modulation along with the changes of the overall load, so that communication between an energy transmitter (Tx) and an energy receiver (Rx) of a wireless charging system during charging could be detected and improved. The inventive apparatus and method make use of variable resistance and controllers to assist with modulating load resistance to modulate load current for wireless energy receiver under charge. The inventive method and apparatus assist with improved communication in wireless charging systems.

### CROSS-REFERENCE TO RELATED APPLICATIONS

The present application claims priority of U.S. Provisional patent application No. 62/553,815 filed on Sep. 2, 2017, the contents of which is herein incorporated by reference.

### FIELD OF THE INVENTION

The invention is related to improved method for communication in general, and to adaptive load of the load modulation for to improving the communication in wireless charging systems in particular.

### BACKGROUND OF THE INVENTION

Load-modulation is a common practice for transfer of data wirelessly. It is commonly used in RF ID, in wireless charging and in other fields. In most of the applications the data is very limited (wireless charging) and sometimes constant (RF ID).

In the case of wireless charging, load modulation is used to transfer data between the energy transmitter (Tx) and the energy receiver (Rx), which is in most cases is the battery charger.

In such usage, the load that the charger reflects to the Tx is composed of the battery load plus the “overhead” of the charger, and the load of the load-modulation (the overhead is the energy that is consumed by the charging IC and does not go to the battery).

For more efficient chargers, the overhead is small and the battery charging becomes the dominated load. In a typical constant current (CC)/constant voltage (CV) charging profile, the current in the pre-charge phase can range from 5% to 10% of the maximal current in the CC stage. The battery voltage might change from value of 2.5V at pre charge to value of 4.2/4.3V towards the end of the charging process. This means that from current perspective the load that the battery reflects at the CC phase can be up to 20 times the load reflected at the pre-charge phase. From energy perspective (current multiplied by voltage) the difference between the minimal load and the maximal load reflected by the battery charging can go even above 20 times.

In load modulation techniques, the load of the communication between an energy transmitter (Tx) and an energy receiver (Rx) of a wireless charging system during charging is added to the charging load. Given that the charging load is changing along the charging process there is a need for a method to change the load of the load modulation along with the changes of the overall load, so the communication could be detected.

### SUMMARY OF THE INVENTION

The present invention provides for an apparatus and method to change the load of the load modulation along with the changes of the overall load, so communication could be detected. The inventive apparatus and method make use of variable resistance and controllers to assist with modulating load resistance to modulate load current for a energy receiver under charge. The inventive method and apparatus assists with improved communication wireless charging systems

### BRIEF DESCRIPTION OF THE DRAWINGS

Examples illustrative of embodiments of the disclosure are described below with reference to figures attached hereto. Dimensions of components and features shown in the figures are generally chosen for convenience and clarity of presentation and are not necessarily shown to scale. Many of the figures presented are in the form of schematic illustrations and, as such, certain elements may be drawn greatly simplified or not-to-scale, for illustrative clarity. The figures are not intended to be production drawings. The figures (Figs.) are listed below.

FIG. 1 is a schematic illustration of a typical resistive load modulation known in the art.

FIG. 2 is a schematic illustration of a typical capacitive load modulation known in the art.

FIG. 3 is a schematic illustration of an example for adaptive resistive load modulation in accordance with the present invention. Whenever the load modulation signal goes active the transistor is turned on and current is drawn from VCC to GND through the resistor R. The resistance of R is tunable and can be changed along the process according to the charging load and the quality of the signal received at the transmitter.

### DETAILED DESCRIPTION

The present invention provides a novel method for improving the communication between an energy transmitter (Tx) and an energy receiver (Rx) of a wireless charging system during charging that is based on adaptive load modulation.

Although various features of the disclosure may be described in the context of a single embodiment, the features may also be provided separately or in any suitable combination. Conversely, although the disclosure may be described herein in the context of separate embodiments for clarity, the disclosure may also be implemented in a single embodiment. Furthermore, it should be understood that the disclosure can be carried out or practiced in various ways, and that the disclosure can be implemented in embodiments other than the exemplary ones described herein below. The descriptions, examples and materials presented in the description, as well as in the claims, should not be construed as limiting, but rather as illustrative.

In adaptive load modulation, the load of the load-modulation is changing with the charging load (or with other criteria, such as feedback from the transmitter that the load-modulation signal is too strong/weak), such that when the charging is at maximal current and maximal voltage the load of the load-modulation will be maximal and when the charging consumes the minimal energy the load of the load-modulation will be minimal. The load of the load-modulation can range between those two extreme points in steps or in linear way.

The best way to understand the value of the load modulation is to look at the current that goes through the load modulation resistor as percentage of the over-all current.

### Example 1

The Battery charging starts at 5 mA (pre-charge). It goes to 100 mA (constant charging). It stops charging at 10 mA (constant voltage end condition). The system operates at 5V and the load modulation resistor is 5K. Table 1 illustrates the results.

TABLE 1

| | Charging current | Load-modulation current | |
|---|---|---|---|
| | (mA) | (mA) | |
| Pre charge | 5 | 1 | 20% |
| Constant current | 100 | 1 | 1% |
| Constant voltage | 10 | 1 | 10% |

It is clear that when the change in the current caused by the load modulation is 1%, it cannot be observed by the transmitter.

In contrast, in an adaptive modulation, the system can change the resistor 5K to 2.5K and 0.5K and the result will be as illustrated in Table 2.

TABLE 2

| | Charging current | Load-modulation current | | |
|---|---|---|---|---|
| | (mA) | (mA) | | |
| Pre charge | 5 | 1 | (@5K) | 20% |
| Constant current | 10 | 2 | (@2.5K) | 20% |
| Constant voltage | 100 | 20 | (@0.5K) | 20% |

It is shown in the above the change in the load as part of the total load remains constant. The adaptive load-modulation can be implemented in many ways such as: varicap, potentiometer controlling a transistor.

Reference is now made to the figures.

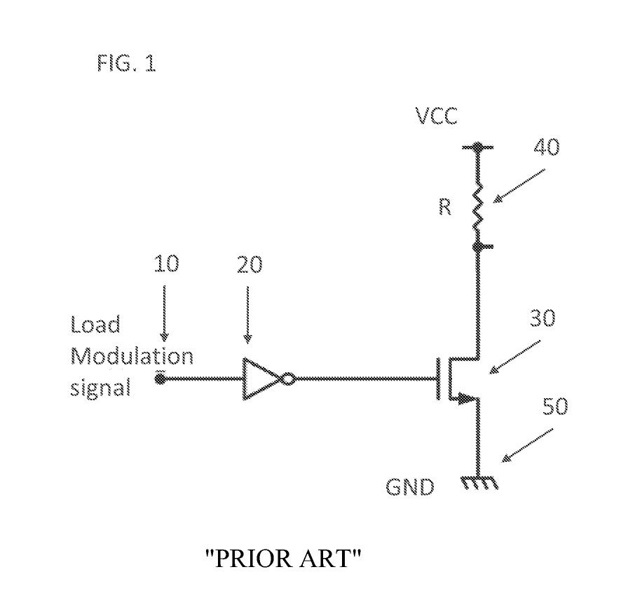

FIG. 1 is a schematic illustration of a typical resistive load modulation known in the art. Whenever the load modulation signal 10 goes active the diode 20 opens and current converts the transistor 30 to an ON position. The current than flows through the resistor 40 from VCC to GND 50.

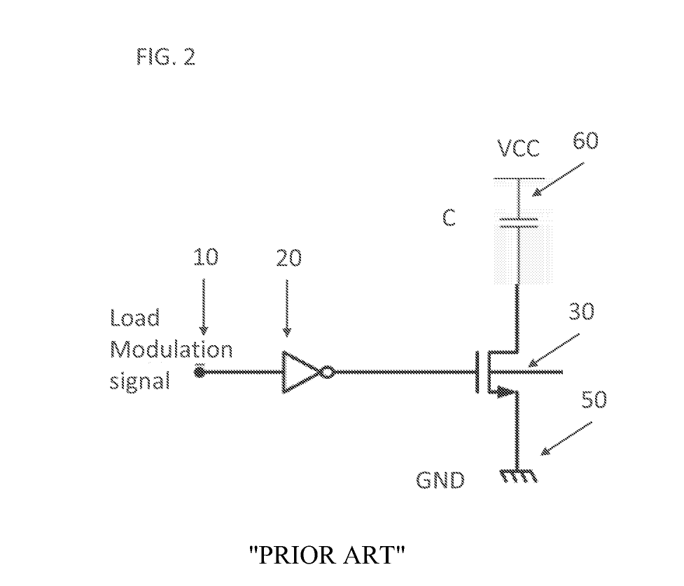

FIG. 2 is a schematic illustration of a typical captive load modulation known in the art. Whenever the load modulation signal 10 goes active the diode 20 opens and current converts the transistor 30 to an ON position. The current than flows through the capacitor 60 from VCC to GND 50.

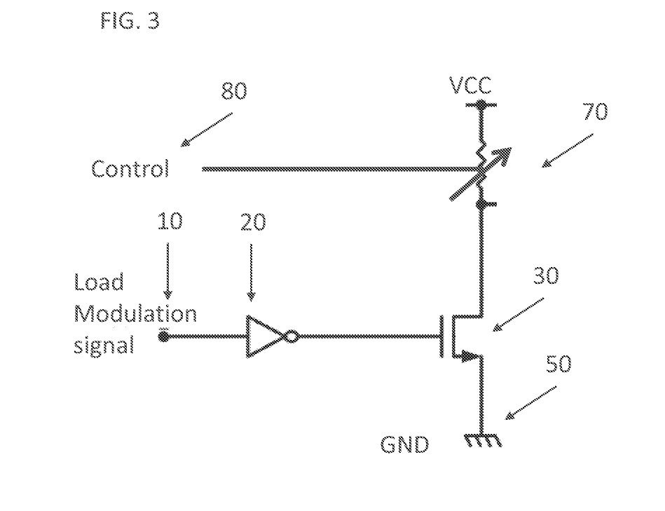

FIG. 3 is a schematic illustration of an example for adaptive resistive load modulation. Whenever the load modulation signal 10 goes active the diode 20 opens and current converts the transistor 30 to an ON position. The current than flows through the changeable resistor 70 from VCC to GND 50. The resistance of changeable resistor 70 is tunable and can be changed by controller 80 along the process according to charging load and additional parameters.

In addition to the above, the adaptive load modulation may also be used for controlling and adjusting the DC charging current. By changing the rate and depth of the modulation the DC charging current may change respectively (increase or decrease).

Furthermore, the adaptive load modulation in some configuration may also be used for adaptive impedance unit.

Yet, in a further embodiment with multi device charging scenario, the adaptive load modulation may additionally be use for balancing the energy distribution between the chargeable devices. By changing the rate and the load of the modulation, the reflected power from the receiving unit may also be change. Consequently, the entire energy distribution of the wireless charging system and the energy balance between the chargeable devices are being changed accordingly.

### Other Embodiments

It should be clear that the description of the embodiments and attached Figures set forth in this specification serves only for a better understanding of the invention, without limiting its scope. It should also be clear that a person skilled in the art, after reading the present specification could make adjustments or amendments to the attached Figures and above described embodiments that would still be covered by the present invention.

1. A method of load modulation for improving communication between an energy transmitter (Tx) and an energy receiver (Rx) of a wireless charging system during charging, the method comprising:
placing an energy receiver within communication range of an energy transmitter;
receiving a load modulation signal based on the charging current of the load; and adjusting the circuit resistance.

2. The method of claim 1 wherein the circuit resistance is tunable and can be changed along the process according to the charging load and the quality of the signal received at the transmitter.

3. The method of claim 1 wherein adjusting the circuit resistance provides adaptive modulation of the load-modulation current.

4. The method of claim 1 wherein the circuit resistance is adjusted using a varicap potentiometer controlling a transistor.

5. The method of claim 1 wherein the circuit resistance comprises a changeable resistor that changes according to the charging phase (pre-charge phase, constant-voltage phase, constant current phase).

6. The method of claim 5 wherein the changeable resistor is changed by a controller along the charging process of the energy receiver according to the charging load.

7. The method of claim 1 further comprising adjusting the circuit impedance in response to a signal received from the transmitter.

8. An apparatus for active load modulation, comprising:
at least one changeable resistor wherein the resistance of said changeable resistor is tunable; and
a controller for providing a load modulation signal to said changeable resistor based on the charging current of the load;
wherein, upon the load modulation signal, current flows through the changeable resistor.

9. The apparatus of claim 8 wherein the resistance of changeable resistor is tunable and can be changed by said controller along the process according to charging load and additional parameters.
